(19) United States
(12) Patent Application Publication
(10) Pub. No.: US 2010/0079828 A1
(43) Pub. Date: Apr. 1, 2010

(54) METHOD FOR OPTIMIZING DISPLAY PROFILES TO SIMULATE THE METAMERIC EFFECTS OF CUSTOM ILLUMINATION

(76) Inventor: Christopher J. Edge, St. Paul, MN (US)

Correspondence Address: Amelia A. Buharin;Patent Legal Staff, Eastman Kodak Company, 343 State Street, Rochester, NY, 14650-2201, US

(21) Appl. No.: 12/404,551

(22) Filed: Mar. 16, 2009

Related U.S. Application Data
(60) Provisional application No. 61/100,804, filed on Sep. 29, 2008.

(51) Int. Cl. H04N 1/46

(52) U.S. Cl. 358/504

(57) ABSTRACT

A method for compensating for effects of illumination when comparing soft proofs to hard copy proofs viewed under non-standard illumination comprises obtaining (110), for a set of print colors, device-independent color data corresponding to the standard illumination and obtaining (120) the corresponding data for the non-standard illumination. The method further comprises estimating (130) first device independent color data to be measured on a display for each color when rendering the set of print colors to the display using the device-independent color data corresponding to the standard illumination and a display profile constructed from color data corresponding to the display, estimating (140) second device independent color data to be measured on the display if the display profile is adjusted, calculating (150) differences between the second device-independent color data and the device-independent color data for the print colors corresponding to the standard illumination and adjusting (160) the display profile to reduce differences.

### CROSS REFERENCE TO RELATED APPLICATIONS

This is a 111A application of Provisional Application Ser. No. 61/100,804, filed Sep. 29, 2009.

### FIELD OF THE INVENTION

This invention relates to adjusting an existing accurate display profile in order to simulate the effects of imperfect standard lighting, such as fluorescent tubes that are designed to simulate D50 lighting.

### BACKGROUND OF THE INVENTION

Fluorescent tubes that are designed to mimic the behavior of daylight (such as the D50 standard for daylight simulation) follow the requirements of international specifications for lighting, for example ISO 3664. These standards were optimized for the requirements of hard copy proofing. This means that different print media such as an ink jet proof and a press sheet must match numerically and visually under a daylight simulator, if calculations using the D50 standard illumination predict that the colors will match.

The standards are less rigorous with regard to the absolute simulation of D50 for a D50 simulator. For example, a solid yellow color printed with an ink jet printer and printing press might shift by 5 ΔE in the direction of green for a particular D50 simulator. That lighting may still be considered an acceptable approximation to D50 as long as the difference between the two colors is small.

This qualification of tubes based on relative versus absolute simulation of D50 is problematic when one attempts to match a display to a printed image viewed in a D50 simulator. In this case, the display may be calibrated and profiled in order to simulate colors viewed with theoretical D50. The ΔE match to D50 can be made very accurate in an absolute sense. If the D50 simulator in fact is significantly different spectrally from D50, resulting in significant shifts in absolute color rendering, there will be significant differences between the printed image in the D50 simulator and the image on the display.

For those who care about such challenges, it is possible to address this issue by measuring the spectra of the illumination, recalculating the values of XYZ and CIELAB, and creating a new ICC profile for characterizing the printed color media. The challenge of this approach is that all profiles would have to be so created for that viewing environment, as well as databases of spot colors which typically contain lists of CIELAB values for each named color, such as lists of Pantone™ color libraries. Although this approach may well be convenient in the future, it is not convenient with current color management infrastructure which is optimized for CIELAB with theoretical D50 illumination.

### SUMMARY OF THE INVENTION

The present invention is a method for compensating for effects of illumination when comparing soft proofs to hard copy proofs viewed under a non-standard illumination that differs from a standard illumination. As shown in FIG. 1, the method comprises obtaining (110), for a set of print colors, device-independent color data corresponding to the standard illumination and obtaining (120), for the set of print colors, device-independent color data that corresponds to the non-standard illumination. The method further comprises estimating (130) first device independent color data to be measured on a display for each color when rendering the set of print colors to the display using the device-independent color data corresponding to the standard illumination and a display profile constructed from color data corresponding to the display, estimating (140) second device independent color data to be measured on the display if the display profile is adjusted, calculating (150) differences between the second device-independent color data and the device-independent color data for the print colors corresponding to the standard illumination and adjusting (160) the display profile to reduce the differences.

### BRIEF DESCRIPTION OF THE DRAWINGS

FIG. 1 is a flow chart showing a method for compensating for effects of illumination when comparing soft proofs to hard copy proofs viewed under a first illumination.

FIG. 2 shows a processor for determining an adjusted RGB profile to simulate the effects of non-standard illumination.

FIG. 3 is a flow chart showing a detailed method for compensating for effects of illumination when comparing soft proofs to hard copy proofs viewed under a first illumination.

### DETAILED DESCRIPTION OF THE INVENTION

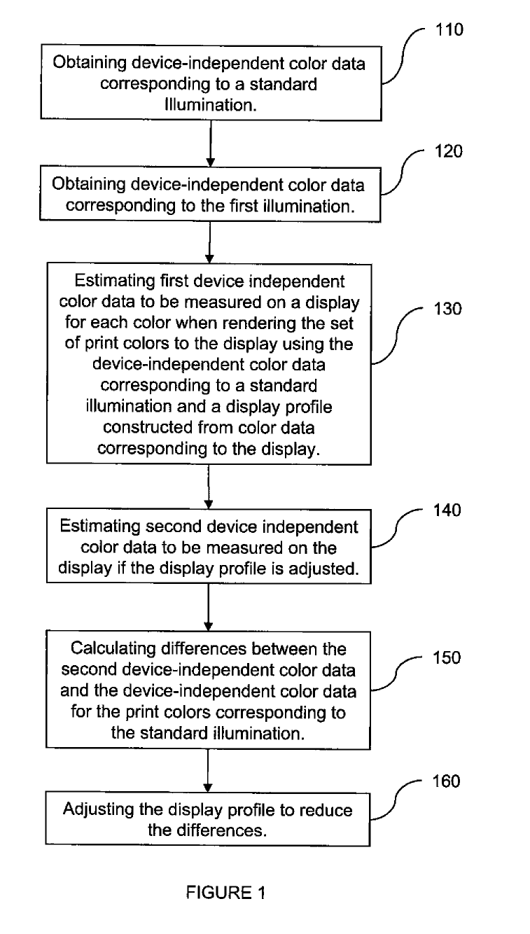

The present invention is a method for compensating for effects of illumination when comparing soft proofs to hard copy proofs viewed under a non-standard illumination that differs from a standard illumination. As shown in FIG. 1, the method comprises obtaining (110), for a set of print colors, device-independent color data corresponding to the standard illumination and obtaining (120), for the set of print colors, device-independent color data that corresponds to the non-standard illumination. The method further comprises estimating (130) first device independent color data to be measured on a display for each color when rendering the set of print colors to the display using the device-independent color data corresponding to the standard illumination and a display profile constructed from color data corresponding to the display, estimating (140) second device independent color data to be measured on the display if the display profile is adjusted, calculating (150) differences between the second device-independent color data and the device-independent color data for the print colors corresponding to the standard illumination and adjusting (160) the display profile to reduce the differences.

The device-independent color data corresponding to the standard illumination can be obtained by determining the reflectance spectra for each print color in the set of print colors and calculating the device independent color data using the standard illumination and the first illumination. The device independent color data for the second illumination can be calculated from direct emissive spectral measurement. The device independent color data can be determined from profiles corresponding to either the standard illumination or the first illumination.

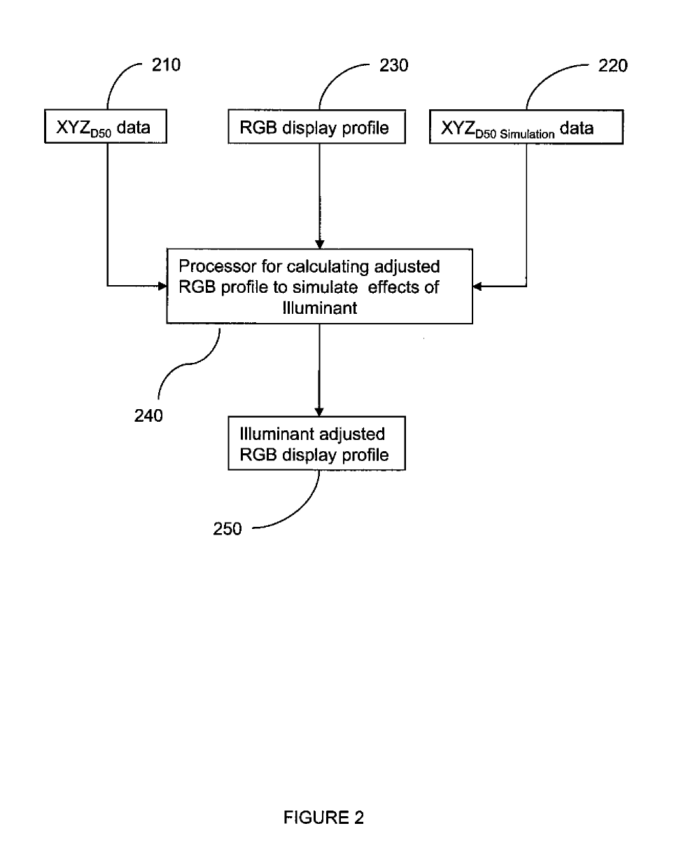

In one embodiment, the present invention proposes to address the above problem via optimized adjustment of the RGB ICC profile used to render color images to the display. The method is executed using the processor system shown in FIG. 2, where the processor 240 uses, for example, XYZ_{D50} data 210, XYZ_{D50Simulation} data 220, and a RGB display profile 230 to calculate an adjusted RGB profile to simulate the effects of the first illumination and output an illuminant adjusted RGB display profile 250.

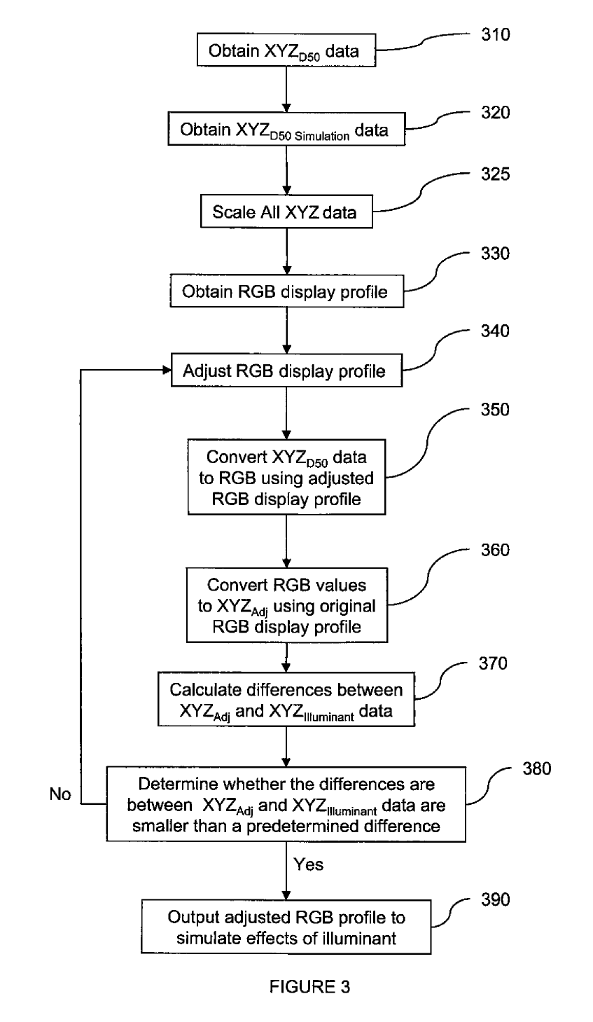

The method, as shown in detail in FIG. 3, is as follows:
Measure (310) CIELAB (or other calorimetric data) or spectral reflectance data for a set of printed colors using a standard reflective measurement device set to D50 or some other chosen reference illuminant;
measure (320) the same colors emissively under the illumination of the D50 simulator or calculate the anticipated emissive measurement by multiplying the spectra of the D50 simulator by the spectral reflectance if so measured in the step above;
for each color, scale (325) the emissive XYZ data and calculate CIELAB by comparing the reflective and emissive data of the whitest color and multiplying each XYZₑₘᵢₛₛᵢᵥₑ by XYZ_{reflective}/XYZₑₘᵢₛₛᵢᵥₑ for the whitest color sample;
identify (330) a display profile that accurately converts RGB to XYZ and XYZ to RGB for that display;
adjust (340) the display profile;
convert (350) each value of XYZ_{D50} to RGB_{display} using the adjusted display profile;
convert (360) RGB_{display} to XYZ_{Adj} with the unadjusted profile;
calculate (370) differences between XYZ_{Adj} and XYZ_{D50 Simulation};
determine (380) whether the differences between XYZ_{Adj} and XYZ_{D50 Simulation} are smaller than a predetermined difference;
if the differences are, smaller than the predetermined difference, then output and save the adjusted RGB display profile, else go back to (340) above.
continue the above process until XYZ′ₑₘᵢₛₛᵢᵥₑ and XYZ_{reflective} are within acceptable tolerances; and
output (390) adjusted RGB profile to simulate effects of illuminant.

Steps (350, 360, and 370) above determine the impact of modifying the RGB profile by converting the colors to the RGB values of the display as though it were performed using color management, then using the accurate unadjusted profile to estimate the measured impact of the adjustment. This should preferably be accomplished by converting XYZ′ₑₘᵢₛₛᵢᵥₑ and XYZ_{reflective} to CIELAB′ₑₘᵢₛₛᵢᵥₑ and CIELAB_{reflective} in order to reduce the error to below a predetermined value in a perceptually uniform color space. An automated approach to the difference reduction process is to define a cost function such as the sum of the squares of the ΔE differences between CIELAB′ₑₘᵢₛₛᵢᵥₑ and CIELAB_{reflective} for the sample set of colors, and proceed to reduce the cost function to below a predetermined value by adjusting the parameters that define the RGB display profile. Well known methods such as Powell's method can be used to perform the automatic iterative error reduction of the cost function.

In one embodiment of the present invention, steps 310 or 320 can be performed by using a profile for the print colors constructed using values of L*a*b* calculated using standard D50 illumination or the simulated D50 illumination and by converting each CMYK color value to XYZ_{reflective} and XYZₑₘᵢₛₛᵢᵥₑ, thereby simulating the results of steps 310 and 320.

Regarding adjustments to the RGB profile, the effects of most D50 simulators can be addressed for chromatic colors by adjusting the values of chromaticities x, y for each RGB channel. Further improvement can be obtained by performing selective adjustments to the 6 RGBCMY vertices of the RGB gamut as described in commonly-assigned U.S. Patent Application Publication No. 2006/0181723 (Edge). In recent tests, accuracy of approximately 1-1.5 ΔE precision was achieved by adjusting chromaticities only, and nearly 0 error achieved by further adjusting the RGBCMY vertices of the RGB profile.

Since spectral measurement devices are often limited in resolution, the actual magnitude of ΔE differences between the appearance of colors under D50 illumination versus under illumination from a D50 simulator may be correct in direction of color but understated in magnitude. A multiplication coefficient, for example, can be used to increase all differences in ΔL*, Δa*, Δb*, etc. in order to capture the true magnitude of visual difference prior to performing the adjustment of the display profile. In an actual test, it was found that multiplying all differences by a factor of 2 exactly captured the true impact of using approximated or simulated D50 illumination versus using actual D50 illumination.

The invention has been described in detail with particular reference to certain preferred embodiments thereof, but it will be understood that variations and modifications can be effected within the scope of the invention.

### PARTS LIST

110 obtaining device-independent color data corresponding to standard illumination
120 obtaining device-independent color data corresponding to the non-standard illumination
130 estimating first device independent color data to be measured on a display
140 estimating second device independent color data to be measured on the display if the display profile is adjusted
150 calculating differences between the second device-independent color data and the device-independent color data
160 adjusting the display profile to reduce the differences
210 XYZ_{D50} data
220 XYZ_{D50Simulation} data
230 RGB display profile
240 processor
250 illuminant adjusted RGB display profile
310 measure CIELAB data
320 measure the same colors emissively
330 identify a display profile
340 adjust the display profile
350 convert each value of XYZ_{D50} to RGB_{display}
360 convert RGB_{display} to XYZ_{Adj} with the unadjusted profile
370 calculate differences between XYZ_{Adj} and XYZ_{D50 Simulation}
380 determine whether the differences between XYZ_{Adj} and XYZ_{D50 Simulation} are smaller than a predetermined difference
390 output adjusted RGB profile to simulate effects of illuminant

1. A method for compensating for effects of illumination when comparing soft proofs to hard copy proofs viewed under a first illumination comprising:
obtaining, for a set of print colors, device-independent color data corresponding to a standard illumination;
obtaining, for the set of print colors, device-independent color data that corresponds to the first illumination;
estimating first device independent color data to be measured on a display for each color when rendering the set of print colors to the display using the device-independent color data corresponding to a standard illumination and a display profile constructed from color data corresponding to the display;
estimating second device independent color data to be measured on the display if the display profile is adjusted;
calculating differences between the second device-independent color data and the device-independent color data for the print colors corresponding to the standard illumination; and
adjusting the display profile to reduce the differences.

2. The method of claim 1, wherein the obtaining comprises determining the reflectance spectra for each print color in the set of print colors and calculating the device independent color data using the standard illumination and the first illumination.

3. The method of claim 1, wherein the device independent color data for the second illumination is calculated from direct emissive spectral measurement.

4. The method of claim 1, wherein the obtaining comprises determining the device independent color data from profiles corresponding to either the standard illumination or the first illumination.
